(19) United States
(12) Patent Application Publication
(10) Pub. No.: US 2026/0129503 A1
(43) Pub. Date: May 7, 2026

(54) USER DEVICE REPORTING OF QUALITY OF EXPERIENCE MEASUREMENT FOR MULTICAST BROADCAST SERVICE IN INACTIVE STATE

(71) Applicant: Lenovo (Singapore) Pte. Ltd., Singapore (SG)

(72) Inventors: Hyung-Nam Choi, Ottobrunn (DE); Joachim Löhr, Wiesbaden (DE)

(21) Appl. No.: 19/114,376

(22) PCT Filed: Sep. 26, 2023
(86) PCT No.: PCT/IB2023/059539

§ 371 Date: Mar. 21, 2025

Related U.S. Application Data
(60) Provisional application No. 63/377,515, filed on Sep. 28, 2022.

(51) Int. Cl. H04W 28/02; H04W 72/542

(52) U.S. Cl. CPC H04W 28/0236; H04W 28/0278; H04W 72/542

(57) ABSTRACT

Various aspects of the present disclosure relate to devices and methods for wireless communication providing enhanced reporting of Quality of Experience (QoE) measurements while a device is in an inactive state. A user equipment (UE) reports, using small data transmission (SDT) in uplink message(s) a first list of a portion of the QoE measurement report(s) limited to a first allocation of uplink resources for SDT. In response to determining that the buffer contains an unreported portion of the one or more QoE measurement reports, the UE receives a second allocation of uplink resources for SDT and reports, using SDT while at least the transceiver of the UE is in an inactive state in second uplink message(s), a second list of a second portion of the QoE measurement report(s) limited to the second allocation of uplink resources for SDT.

### PRIORITY APPLICATION

The application claims priority to U.S. Provisional Application No. 63/377,515 filed Sep. 28, 2022, the content of which is fully incorporated herein.

### TECHNICAL FIELD

The present disclosure relates in general to a communication device, and more particularly to communication devices that report quality of experience measurements.

### BACKGROUND

A wireless communications system may include one or multiple network communication devices, including base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, and other suitable radio access technologies beyond 5G (e.g., sixth generation (6G)).

Quality of Experience (QoE) measurement is an important metric for the design and operation of wireless communication systems, especially for video services that have high traffic demands. Bad network performance may significantly affect the user's experience. QoE metrics are often measured at an end device and can conceptually be seen as the remaining quality after the distortion introduced during the preparation of the content and the delivery through the network, until reaching a decoder at the end device. Reporting of QoE by the end device to a network entity that manages QoE is required to identify and mitigate degradation in transmissions that reduce QoE.

### SUMMARY

The present disclosure relates to methods, apparatuses, and systems providing wireless communication with reporting of Quality of Experience (QoE) measurements for multicast broadcast service (MBS) in an inactive state. Small Data Transmission (SDT) is used by a device to enable the device to maintain power consumption efficiencies of remaining in an inactive state with regard to communicating with a network device of a radio access network (RAN). When reporting buffer data size to the network, the device does not include the size of QoE measurement reports in the buffer. Instead, the device is able to control transmission of the QoE reports and avoid the discarding of QoE reports.

Some implementations of the method and apparatuses described herein may include a method for wireless communication at a user device. In one or more embodiments, the method includes receiving, via a transceiver of a user device from a network device, one or more control messages. The user device determines that the one or more control messages enable small data transmission using a first allocation of uplink resources while at least the transceiver of the device is in an inactive state. The user device further determines that the one or more control messages enable generation and transmission of QoE measurement reports. In response, the method includes measuring QoE at the user device and storing one or more QoE measurement reports in the buffer. The method includes reporting, using SDT in at least one first uplink message while at least the transceiver of the device is in an inactive state, a first list of a portion of the one or more QoE measurement reports limited to the first allocation of uplink resources for SDT. In response to determining that the buffer contains an unreported portion of the one or more QoE measurement reports, the method may further include receiving a second allocation of uplink resources for SDT. The method may further include reporting, in at least one second uplink message, a second list of a second portion of the one or more QoE measurement reports. The method includes reporting the second list using SDT while at least the transceiver of the device is in an inactive state. The method includes reporting the second list as limited to the second allocation of uplink resources for SDT.

Some implementations of the method and apparatuses described herein may include a method for wireless communication at a network device. In one or more embodiments, the method may include transmitting, via a transceiver of a network device to a user device, one or more control messages to enable: (i) SDT using a first allocation and subsequent second allocations of uplink resources for SDT, while at least the transceiver of the user device is in an inactive state; and (ii) generation of QoE measurement reports. The one or more control messages are intended to prompt the user device to measure QoE and store one or more QoE measurement reports in a buffer. The method may include receiving from the user device in at least one first uplink message while at least the transceiver of the user device is in an inactive state, a first list of a portion of the one or more QoE measurement reports limited to a first allocation of uplink resources for SDT. The method may include receiving from the user device in at least one other uplink message while at least the transceiver of the user device is in an inactive state, a second list of a portion of the one or more QoE measurement reports limited to a second allocation of uplink resources for SDT. The method may include communicating the first list and the second list to a Measurement Collection Entity (MCE).

### BRIEF DESCRIPTION OF THE DRAWINGS

FIG. 1 illustrates an example of a wireless communications system enabling wireless communication that supports Quality of Experience (QoE) measurement reporting for Multicast and Broadcast Services (MBS) in an inactive state, in accordance with aspects of the present disclosure.

FIG. 2 is a state diagram of user device state and state transitions, in accordance with aspects of the present disclosure.

FIG. 3 is an exemplary message flow diagram for signaling-based initiated QoE measurement collection (QMC) activation and deactivation, in accordance with aspects of the present disclosure.

FIG. 4 is an exemplary uplink access stratum protocol layer configuration when QoE measurement reporting is configured, in accordance with aspects of the present disclosure.

FIG. 5 is a diagram of a communication environment of multicast/broadcast services, in accordance with aspects of the present disclosure.

FIG. 6 is a signaling diagram of a communication environment between a user device and a network for reception of MBS broadcast services, in accordance with aspects of the present disclosure.

FIG. 7 is an exemplary message flow diagram of a communication environment between a UE and a base node performing random access (RA)-based Small Data Transmission (SDT) using the contention-based 2-step Random Access Channel (RACH) procedure with subsequent data transmissions, in accordance with aspects of the present disclosure.

FIG. 8 is a diagram of an example measurement report application layer message, in accordance with aspects of the present disclosure.

FIG. 9 is a diagram of a measurement report application layer (“MeasurementReportAppLayer”) message whose content is segmented for uplink transmission, in accordance with aspects of the present disclosure.

FIG. 10 is an ASN.1 signaling structure for configuring QoE measurement reporting in SDT, in accordance with aspects of the present disclosure.

FIG. 11 is a flow diagram that presents a method for QoE measurement reporting while a device is in an inactive state, in accordance with aspects of the present disclosure.

FIG. 12 is a message flow diagram of a communication network of a UE and a gNB performing one embodiment of reporting QoE in an inactive state using SDT, in accordance with aspects of the present disclosure.

FIG. 13 is a diagram of a Radio Resource Control (RRC) buffer that is used to store QoE measurement reports, in accordance with aspects of the present disclosure.

FIG. 14 illustrates an example of a block diagram of a device that supports wireless communication with QoE measurement reporting in RRC inactive state, in accordance with aspects of the present disclosure.

FIG. 15 illustrates a flowchart of a method performed by a user device that supports wireless communication with QoE measurement reporting in inactive state, in accordance with aspects of the present disclosure.

FIG. 16 illustrates a flowchart of a method performed by a network device that supports wireless communication that prompts QoE measurement reporting by a user device in an inactive state, in accordance with aspects of the present disclosure.

### DETAILED DESCRIPTION

New Radio (NR) Quality of Experience (QoE) measurement information enables operators of streaming, Multimedia Telephony Service for Internet Protocol Multimedia Subsystem (MTSI), and virtual reality (VR) services to better understand the user experience and optimize their NR network for the concerned services. A user equipment (UE) receives QoE measurement configurations from a communication network. The application layer of the UE collects QoE measurements for the configured services. The access stratum (AS) layer of the UE reports the collected QoE measurements to the communication network.

Generally known QoE measurement collection (QMC) are only supported in Radio Resource Control (RRC) connected (“RRC_CONNECTED”) state. When the UE is transferred by the network from RRC_CONNECTED to RRC idle (“RRC_IDLE”) state, the UE releases all QoE measurement configurations. When the UE is transferred by the network from the RRC connected state to RRC inactive (“RRC_INACTIVE”) state, the UE keeps the QoE measurement configurations without measuring and reuses the same configurations upon transfer from RRC inactive state back to RRC connected state.

Multicast and Broadcast Services (MBS) is specified for NR radio access technology (RAT) to allow the resource-efficient and reliable transmission of MBS traffic data to multiple UEs in a specific service area at the same time in a radio access network (RAN). For broadcast services, the same traffic data content is transmitted to all UEs located in a specific service area. For multicast services, the same traffic data content is transmitted to a group of UEs located in a specific service area. MBS multicast services are specified to be supported only in RRC connected state, whereas MBS broadcast services are specified to be supported in all RRC states (i.e., RRC connected state, RRC inactive state, and RRC idle state).

Small data transmission (SDT) has been specified for NR RAT to support efficient transmission of small and infrequent data packets for mobile originated (MO) data traffic in RRC inactive state without the transfer to RRC connected state. SDT in RRC inactive state can be performed by an SDT-capable UE when SDT resources have been configured by an NR base node (“gNB”) via broadcast and/or dedicated signaling, and when the amount of uplink (UL) data across all radio bearers for which SDT has been enabled is lower than a configured data volume threshold (DVT). If the amount of UL data across all radio bearers for which SDT has been enabled is larger than the configured data volume threshold, then the UE initiates legacy RRC connection resume procedure to resume the UL data transmission in RRC connected state. Generally known SDT procedures do not support the reporting of collected QoE measurements.

NR QoE are specified to be enhanced to support further advanced services such as augmented reality (AR), mixed reality (MR) and MBS. Specifically for MBS, the QoE measurement collection will be extended to RRC inactive and idle states in addition to RRC connected state to enable the network to verify and optimize the performance of MBS at a given location and irrespective of the UE RRC state. With regard to configuration, release, collection and reporting of QoE measurements for MBS, the UE is configured with QoE measurements in RRC inactive and idle states for MBS via RRC. The UE buffers the QoE reports generated while in RRC inactive and idle states to ensure that the UE does not initiate the RRC connection establishment procedure when in RRC idle state or the RRC connection resume procedure when in RRC inactive state for QoE measurement reporting whenever the AS layer of the UE receives a QoE report from the application layer of the UE. In one or more embodiments, a buffer for storing QoE measurements reports while the device is in an inactive state may be located in the Access Stratum (AS) layer (i.e., RRC layer) or the application layer.

When the UE moves to RRC connected state, the UE sends the QoE measurements availability indication to the base node. With regards to reporting of QoE measurements collected in RRC inactive state, the UE need not report the QoE measurements in RRC connected state when both the UE and base node support SDT. Instead, the UE performs QoE measurement reporting in RRC inactive state during the SDT procedure allowing efficient transmission of QoE measurements from the UE to the base node in terms of signaling overhead and UE power consumption.

To enable this capability of QoE measurements in RRC inactive state, the present disclosure addresses handling of oversized QoE reports and UL RRC messages in SDT. The size of each buffered QoE report varies depending on the configured service type (e.g., for MBS multicast or broadcast service) and reporting interval. The size of a single QoE report may be smaller or larger than 9 kBytes. The total amount of buffered QoE reports may exceed 9 kBytes, which is equivalent to the maximum packet data convergence protocol (PDCP) service data unit (SDU) size limit.

The QoE reports need to be sent by UE AS layer to the base node in an UL RRC message, e.g., the RRC MeasurementReportAppLayer message. The UL RRC message may carry a single or multiple QoE reports. However, if the size of the UL RRC message exceeds the maximum RRC packet data unit (PDU) size of 9 kBytes, then the RRC message needs either to be discarded or to be segmented by the UE. Segmentation can only be performed if both UE and base node support UL RRC segmentation and segmentation for SDT has been enabled by the base node. The present disclosure provides UL RRC segmentation for SDT.

To enable this capability of QoE measurements in RRC inactive state, the present disclosure also addresses handling of buffered QoE reports in SDT, specifically how the buffered QoE reports should be considered in the calculation of the data volume. One option is to extend the data volume calculation to the buffer in RRC layer or application layer. Another option is to perform the data volume calculation based on the buffers in PDCP and RLC entities. The UE RRC processes the buffered QoE reports when triggered to report the QoE reports and sends the QoE reports via the MeasurementReportAppLayer message to lower layers for transmission. However, both options have the high risk that the resulting calculated data volume will exceed the configured threshold. When this happens, the UE will not perform SDT and instead will initiate legacy RRC connection resume procedure to resume the UL data transmission in connected state, forgoing the gains of SDT.

The present disclosure addresses these and other issues by enhancing SDT and QoE application layer measurement reporting procedure for efficient reporting of collected QoE measurements for MBS in the inactive state. The base node indicates to the user device in an RRC release (“RRCRelease”) message whether SRB4 and UL RRC segmentation is enabled for the UE. The QoE reports which are generated in inactive state are buffered in RRC layer and the RRC buffer is not considered in the calculation of the data volume. The QoE measurement reporting procedure in RRC is enhanced for SDT by controlling the reporting of buffered QoE reports in inactive state according to the actual data volume of the buffers in the PDCP and RLC entities and whether UL RRC segmentation has been enabled or not.

In one or more embodiments, an apparatus and method are provided for transmitting quality of experience (QoE) measurement reports in RRC inactive state by a communication device in a communication network. The communication device receives a first message from the communication network enabling the QoE measurement collection and transmission of QoE measurement reports in RRC inactive state. The communication device performs and collects the QoE measurements in accordance with the received first message. The communication device stores the QoE measurement reports in a buffer of the communication device memory located in RRC. The communication device determines a list of QoE measurement reports that are buffered in the device's RRC buffer for transmission. The communication device transmits a second message to the communication network containing the determined list of QoE measurement reports and using radio resources allocated for transmitting UL data in RRC inactive state.

In one or more embodiments, the first message contains the information whether signaling radio bearer 4 (SRB4) and UL RRC segmentation is enabled. In one or more embodiments, the list of QoE measurement reports to transmit is determined based on the available data volume in the layer 2 buffers and whether UL RRC segmentation is enabled.

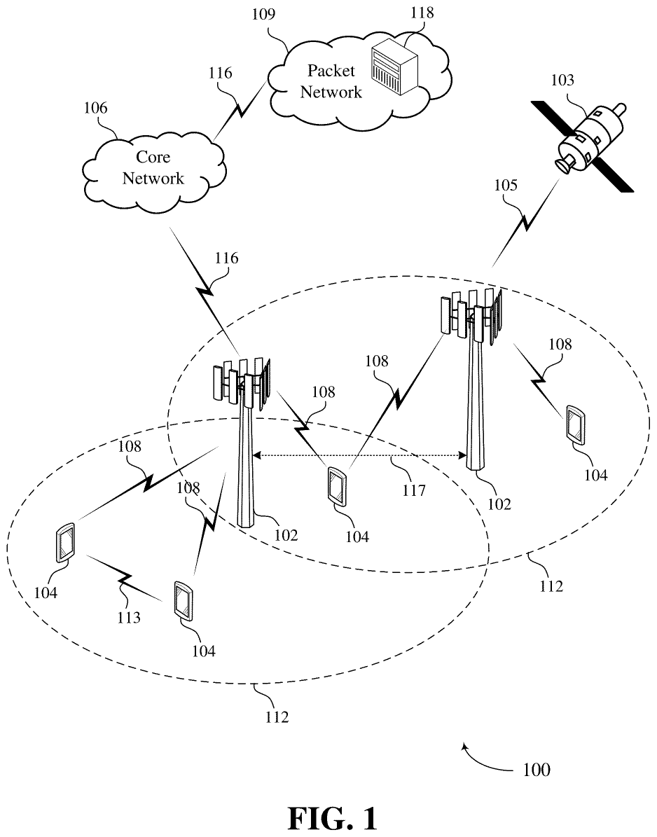

FIG. 1 illustrates an example of a wireless communications system 100 enabling wireless communication that supports enhanced QoE measurement reporting, in accordance with aspects of the present disclosure. The wireless communications system 100 may include one or more network devices 102, one or more UEs 104, a core network 106, and a packet data network 109. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a New Radio (NR) network. In other implementations, the wireless communications system 100 may be a combination of a 4G network and a 5G network. The wireless communications system 100 may support radio access technologies beyond 5G, or other suitable radio access technology including Institute of Electrical and Electronics Engineers (IEEE) 802.11 (Wi-Fi), IEEE 802.16 (WiMAX), IEEE 802.20. Additionally, the wireless communications system 100 may support technologies, such as time division multiple access (TDMA), frequency division multiple access (FDMA), or code division multiple access (CDMA), etc.

The one or more network devices 102 may be dispersed throughout a geographic region to form the wireless communications system 100. One or more of the network devices 102 described herein may be, may include, or may be referred to as a network node, a base station, a network element, a radio access network (RAN), a base transceiver station, an access point, a NodeB, an eNodeB (CNB), a next-generation NodeB (gNB), a network device, or other suitable terminology. A network device 102 and a UE 104 may communicate via a communication link 108, which may be a wireless or wired connection. For example, a network device 102 and a UE 104 may wirelessly communicate (e.g., receive signaling, transmit signaling) over the air (Uu) interface.

A network device 102 may provide a geographic coverage area 112 for which the network device 102 may support services (e.g., voice, video, packet data, messaging, broadcast, etc.) for one or more UEs 104 within the geographic coverage area 112. For example, a network device 102 and a UE 104 may support wireless communication of signals related to services (e.g., voice, video, packet data, messaging, broadcast, etc.) according to one or multiple radio access technologies. In some implementations, a network device 102 may be moveable, for example, a satellite 103 associated with a non-terrestrial network that communicates via a link 105 to network devices 102. In some implementations, different geographic coverage areas 112 associated with the same or different radio access technologies may overlap, but the different geographic coverage areas 112 may be associated with different network devices 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network devices 102, other UEs 104, or network equipment (e.g., the core network 106, the packet data network 109, a relay device, an integrated access and backhaul (IAB) node, or another network equipment), as shown in FIG. 1. Additionally, or alternatively, a UE 104 may support communication with other network devices 102 or UEs 104, which may act as relays in the wireless communications system 100.

A UE 104 may also be able to support wireless communication directly with other UEs 104 over a communication link 113. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 113 may be referred to as a sidelink. For example, a UE 104 may support wireless communication directly with another UE 104 over a PC5 interface. PC5 refers to a reference point where the UE 104 directly communicates with another UE 104 over a direct channel without requiring communication with the network device 102.

A network device 102 may support communications with the core network 106, or with another network device 102, or both. For example, a network device 102 may interface with the core network 106 through one or more backhaul links 116 (e.g., via an S1, N2, or another network interface). The network devices 102 may communicate with each other over the backhaul links 116 (e.g., via an X2, Xn, or another network interface). In some implementations, the network devices 102 may communicate with each other directly (e.g., between the network devices 102) via a link 117. In some other implementations, the network devices 102 may communicate with each other indirectly (e.g., via the core network 106). In some implementations, one or more network devices 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

In some implementations, a network entity or network device 102 may be configured in a disaggregated architecture, which may be configured to utilize a protocol stack physically or logically distributed among two or more network entities or network devices 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity or network device 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities or network devices 102 in a disaggregated RAN architecture may be co-located, or one or more components of the network entities or network devices 102 may be located in distributed locations (e.g., separate physical locations). In some implementations, one or more network entities or network devices 102 of a disaggregated RAN architecture may be implemented as virtual units (e.g., a virtual CU (VCU), a virtual DU (VDU), and/or a virtual RU (VRU)).

The split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaptation protocol (SDAP), and Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities or network devices 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more network devices 102 associated with the core network 106.

The core network 106 may communicate with the packet data network 109 over one or more backhaul links 116 (e.g., via an S1, N2, N2, or another network interface). The packet data network 109 may include an application server 118. In some implementations, one or more UEs 104 may communicate with the application server 118. A UE 104 may establish a session (e.g., a protocol data unit (PDU) session, or the like) with the core network 106 via a network entity or network device 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities or network devices 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities or network devices 102 and the UEs 104 may support different resource structures. For example, the network entities or network devices 102 and the UEs 104 may support different frame structures. In some implementations, such as in 4G, the network entities or network devices 102 and the UEs 104 may support a single frame structure. In some other implementations, such as in 5G and among other suitable radio access technologies, the network entities or network devices 102 and the UEs 104 may support various frame structures (i.e., multiple frame structures). The network entities or network devices 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, (=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHZ), FR4a or FR4-1 (52.6 GHz-71 GHz), and FR5 (114.25 GHz 300 GHz). In some implementations, the network entities or network devices 102 and the UEs 104 may perform wireless communications over one or more of the operating frequency bands. In some implementations, FR1 may be used by the network entities or network devices 102 and the UEs 104, among other equipment or devices for cellular communications traffic (e.g., control information, data). In some implementations, FR2 may be used by the network entities or network devices 102 and the UEs 104, among other equipment or devices for short-range, high data rate capabilities.

FRI may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

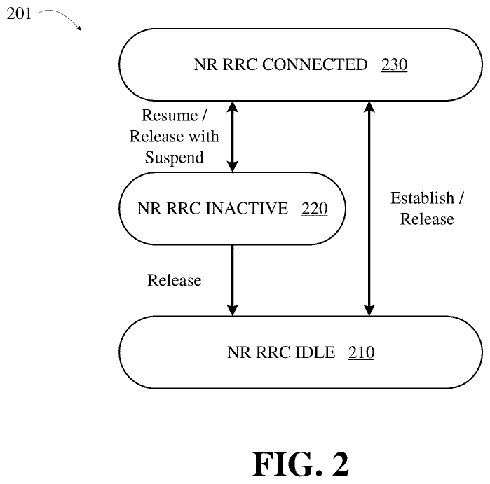

FIG. 2 is a state diagram 201 of UE state and state transitions in NR RAT. For better understanding of the solutions that are proposed in the present disclosure, certain features and functionalities are described such as UE states and state transitions. NR RRC idle state (“RRC_IDLE”) 210 may transfer to NR RRC connected (“RRC_CONNECTED”) state 230. NR RRC inactive state 220 may transfer to either NR RRC idle state 210 or to NR RRC connected state 230. As specified, a UE 104 (FIG. 1) is either in RRC_CONNECTED state 230 or in RRC_INACTIVE state 220 when an RRC connection has been established. If this is not the case, i.e., no RRC connection is established, the UE is in RRC_IDLE state 210. The RRC states can further be characterized as follows:

In RRC_IDLE state, the UE:
(i) Monitors short messages transmitted with paging radio network temporary identifier (P-RNTI) over downlink control information (DCI);
(ii) Monitors a paging channel for core network (CN) paging using NR system temporary mobile subscriber identify (5G-S-TMSI);
(iii) Monitors a paging channel for CN paging using temporary mobile group identity (TMGI) if configured by upper layers for MBS multicast reception;
(iv) Performs neighboring cell measurements and cell (re-) selection;
(v) Acquires system information and can send system information (SI) request when configured to do so by the base node;
(vi) Performs logging of available measurements together with location and time for logged measurement configured UEs;
(v) Performs idle/inactive measurements for idle/inactive measurement configured UEs; and
(vi) Acquires MBS control channel (MCCH) change notification and MBS broadcast control information and data when configured by upper layers for MBS broadcast reception.

In RRC_INACTIVE, the UE:
(i) Monitors short messages transmitted with P-RNTI over DCI;
(ii) During small data transmission (SDT) procedure, monitors control channels associated with the shared data channel to determine if data is scheduled for the shared data channel;
(iii) While SDT procedure is not ongoing, monitors a paging channel for CN paging using 5G-S-TMSI and RAN paging using full I-RNTI;
(iv) Monitors a paging channel for paging using TMGI when configured by upper layers for MBS multicast reception;
(v) Performs neighboring cell measurements and cell (re-) selection;
(vi) Performs RAN-based notification area updates periodically and when moving outside the configured RAN-based notification area;
(vii) Acquires system information, while SDT procedure is not ongoing, and can send SI request when configured;
(viii) While SDT procedure is not ongoing, performs logging of available measurements together with location and time for logged measurement configured UEs;
(ix) While SDT procedure is not ongoing, performs idle/inactive measurements for idle/inactive measurement configured UEs;
(x) Acquires MCCH change notification and MBS broadcast control information and data when configured by upper layers for MBS broadcast reception; and
(xi) Transmits sounding reference signal (SRS) for positioning;

In RRC_CONNECTED state, the UE:
(i) Transmits or receives unicast data;
(ii) Receives MBS multicast data;
(iii) Monitors Short Messages transmitted with P-RNTI over DCI, when configured;
(iv) Monitors control channels associated with the shared data channel to determine when data is scheduled for the shared data channel;
(v) Provides channel quality and feedback information;
(vi) Performs neighboring cell measurements and measurement reporting;
(vii) Acquires system information;
(viii) Performs immediate MDT measurement together with available location reporting; and
(ix) Acquires MCCH change notification and MBS broadcast control information and data when configured by upper layers for MBS broadcast reception.

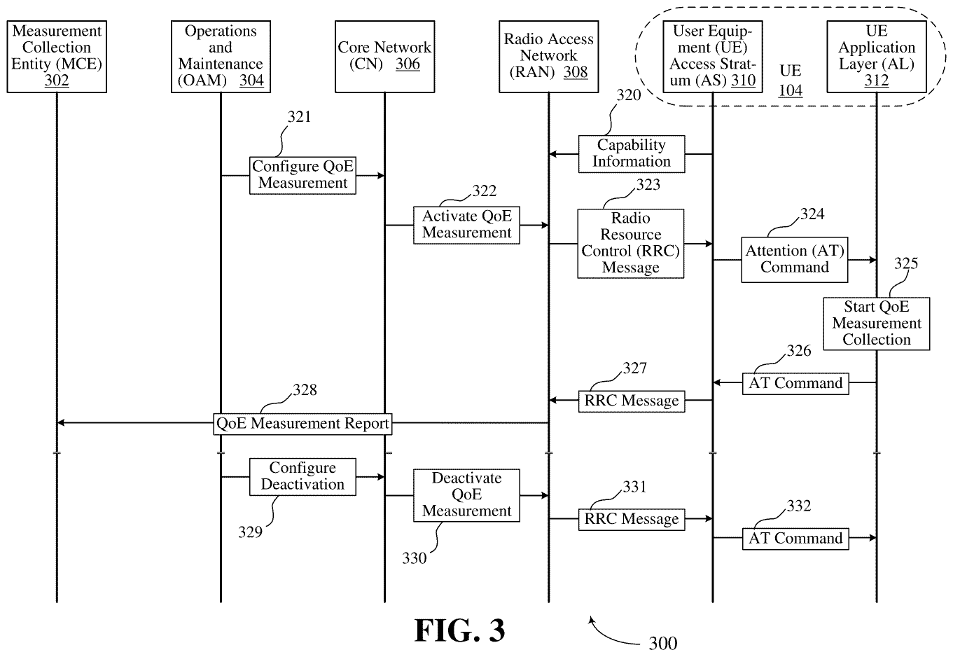

FIG. 3 is an exemplary message flow diagram for signaling-based initiated QoE measurement collection (QMC) activation and deactivation. A communication environment 300 includes a measurement collection entity (MCE) 302, an operations and maintenance (OAM) 304, a core network (CN) 306, radio access network (RAN) 308, UE access stratum (AS) 310, and UE application layer (AL) 312 of UE 104. The communication environment 300 may perform QMC for streaming, MTSI, and VR services over the RAN 308, including OAM initiated QMC activation/deactivation (via signaling-based and management-based initiation). The signaling-based method is a C-plane method where the CN 306 is involved, and the CN 306 determines the qualified UEs 104 to send the QoE measurement configuration. According to this method, the OAM 304 initiates QMC triggering CN 306 to activate QMC towards RAN 308. By contrast, the management-based method is a method wherein the CN 306 is not involved, and the OAM 304 directly activates/deactivates a QoE measurement configuration towards RAN 308.

At 320 (“Step 0”), RAN 308 receives UE capability information from UE AS layer 310. The UE capability information indicates whether or not the UE 104 supports QMC. At 321 (“Step 1”), OAM 304 is interested in receiving QoE measurements for certain services from UEs 104 that are being serviced in a public land mobile network (PLMN) and sends to CN a “Configure QoE measurement” message. The “Configure QoE measurement” message may include information such as service type, area scope (list of cells or list of tracking areas (TAs)), QoE collection entity address (IPv4 or IPv6 address of the MCE 302 to which the QoE measurement reports shall be transferred), QoE reference (QoE measurement collection session identifier in the network), and the QoE measurement configuration container (i.e., QoE measurement configuration that is relevant for the UE AL 312 and that is encapsulated in a container). At 322 (“Step 2”), in accordance with the received QoE measurement configuration from OAM 304, the CN 306 activates the QoE measurement configuration for a qualified UE 104 and forwards the QoE measurement configuration to RAN 308 using an “Activate QoE measurement” message. At 323, (“Step 3”), RAN 308 sends the QoE measurement configuration in a DL RRC message to the UE AS layer 310. At 324 (“Step 4”), the UE AS layer 310 sends the received QoE measurement configuration to the UE AL 312 using AT command, where “AT” stands for ATtention.

At 325 (“Step 5”), the UE AL 312 starts QoE measurement collection in accordance with the received QoE measurement configuration. The QoE measurement configuration may include parameters such as PLMN target, session to record of an application, service type, area scope (list of cells or list of TAs), QoE metrics of the concerned service type and reporting interval. For instance, QoE metrics for streaming services include, amongst other things, Average Throughput, Initial Playout Delay, Buffer Level, Play List, and Device information. At 326 (“Step 6”), if the QoE measurements have been collected according to the configuration parameters, the UE AL sends the collected QoE measurement results to its AS layer in a QoE measurement report container using AT command. At 327 (“Step 7”), the UE AS layer 310 sends the QoE measurement report container in a UL RRC message to RAN 308. At 328 (“Step 8”), RAN 308 forwards the received QoE measurement report container to the MCE 302. The RRC message in Step 3 may be the “RRCReconfiguration” message, and the RRC message in Step 7 may be the “MeasurementReportAppLayer” message. The RRCReconfiguration message is sent on signaling radio bearer 1 (SRB1) and may contain one or multiple QoE measurement configurations. The MeasurementReportAppLayer message is sent on signaling radio bearer 4 (SRB4) and may contain one or multiple QoE measurement reports.

If OAM 304 is not interested in receiving QoE measurements for certain services from UEs 104 anymore, such as when OAM 304 has enough QoE information for those services, then OAM 304 initiates QMC deactivation. At 329 (“Step 9”), OAM 304 sends to CN 306 a “Configure Deactivation” message including an indication of the concerned service(s). At 330 (“Step 10”), in accordance with the received “Configure Deactivation” message from OAM 304, the CN 306 sends “Deactivate QoE measurement” message to RAN 308 with the indication for which UE 104 the concerned QoE measurement configuration should be deactivated. At 331 (“Step 11”), RAN 308 sends the deactivation indication in a DL RRC message to the UE AS layer 310 to release the concerned QoE measurement configuration. The RRC message may be the RRCReconfiguration message. At 332 (“Step 12”), the UE AS layer 310 sends the received deactivation indication to UE AL 312 using AT command. The UE AL 312 stops the recording and reporting of the concerned QoE measurements.

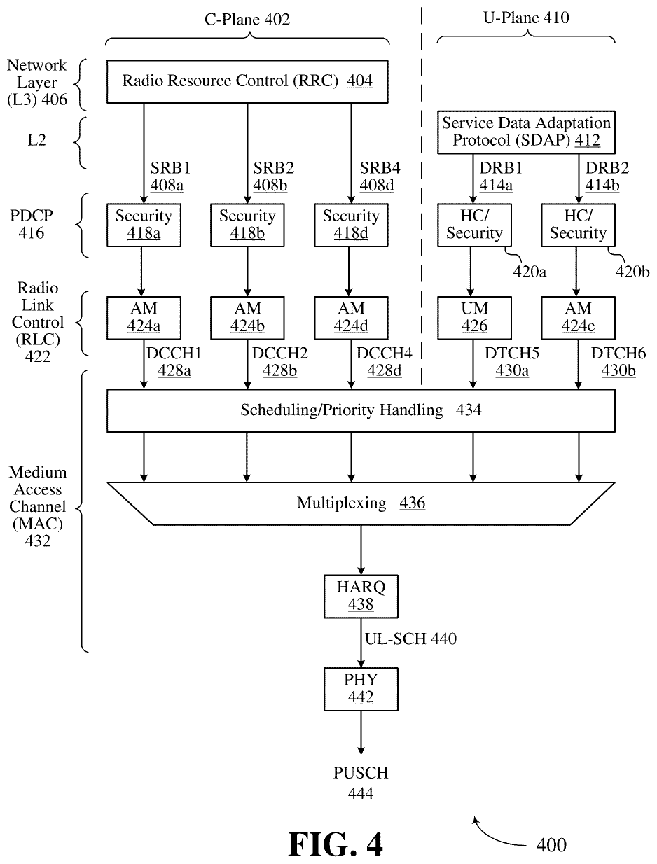

FIG. 4 is an exemplary UL AS protocol layer configuration 400 when NR QoE is configured. In C-plane 402, three (3) SRBs are configured for transmitting data from RRC sublayer 404 of network layer or Layer 3 (L3) 406: SRB1 408a for transmitting high priority RRC messages; SRB2 408b for transmitting NAS messages; and SRB4 408d for transmitting the lower priority MeasurementReportAppLayer message. In U-plane 410, two (2) data radio bearers (DRBs) are configured for transmitting data from service data adaptation protocol (SDAP) sublayer 412: DRB1 414a for transmitting data of a MTSI service; and DRB2 414b for transmitting data of a VR service.

In PDCP sublayer 416, each RB (SRB or DRB) is associated with one PDCP entity 418a, 418b, 418d, 420a, and 420b. In accordance with the configuration received from the gNB, each PDCP entity performs, amongst other functions (e.g., re-ordering, timer-based discarding, duplication), header compression and/or security (e.g., integrity protection and ciphering) for the UL data to be transmitted. SRB1 408a is received by PDCP entity 418a for security. SRB2 408b is received by PDCP entity 418b for security. SRB4 408d is received by PDCP entity 418d for security. DRB1 414a is received by PDCP entity 420a for header compression and security. DRB2 414b is received by PDCP entity 420b for header compression and security.

In RLC sublayer 422, each PDCP entity 418a, 418b, and 418d is associated with respective acknowledged mode (AM) of transmission RLC entities 424a, 424b and 424d. PDCP entity 420a is associated with unacknowledged mode (UM) of transmission RLC entity 426. PDCP entity 420b is associated with AM mode RLC entity 424e. Each RLC entity 424a, 424b, 424d, 424e and 426, receives UL data from the associated PDCP entity 418a, 418b, 418d, 420a, and 420b and sends the UL data respectively via dedicated control channel 1 (DCCH1) 428a, DCCH2 428b, DCCH4 428d, dedicated traffic channel 5 (DTCH5) 430a, and DTCH6 430b to MAC sublayer 432. MAC sublayer 432 includes scheduling/priority handling function 434, then multiplexing function 436, and then hybrid automatic repeat request (HARQ) function 438 that communicates via uplink shared channel 440 to physical (PHY) layer 442 for transmitting physical uplink shared channel (PUSCH) 444. In MAC sublayer 432, the UE 104 (FIG. 1) creates a single MAC PDU (non-multiple input multiple output (MIMO) case) to be transmitted on PUSCH 444 in PHY layer 442. A MAC PDU refers to a transport block and contains UL data from the different logical channels, which are also referred to as a logical channel prioritization (LCP) procedure. The UE 104 (FIG. 1) performs the scheduling and priority handling of the UL data from the different logical channels in accordance with the configuration received from the network entity or network device 102 (FIG. 1) (e.g., gNB).

The network controls the scheduling and priority handling of UL data by the following main parameters:
(i) priority in the range 1 to 16, where value 1 is highest priority and value 16 is lowest priority. The parameter is set for each configured logical channel.
(ii) “prioritisedBitRate” that sets the Prioritized Bit Rate (PBR) in the value range {0 KBps, 8 kbps, 16 kBps, 32 KBps, 64 KBps, 128 KBps, 256 kBps, 512 KBps, 1024 KBps, 2048 kBps, 4096 kBps, 8192 KBps, 16384 KBps, 32768 kBps, 65536 kBps, infinity}. For SRBs, the PBR is set to infinity. The PBR corresponds to a guaranteed minimum bit rate.
(iii) “bucketSizeDuration” which sets the Bucket Size Duration (BSD) in the value range {5 ms, 10 ms, 20 ms, 50 ms, 100 ms, 150 ms, 300 ms, 500 ms, 1000 ms}. The bucket size duration indicates the time for transmitting uplink data of a logical channel by using the prioritized bit rate until the bucket size (i.e., PBR×BSD) is reached.

The above parameters ensure that the UE transmits the UL data according to the QoS of each configured radio bearer and the allocated radio resources. According to the current specified LCP procedure the UE shares UL resources among the configured LCHs based on the LCH priority and the prioritized bit rate configured for an LCH. The idea behind prioritized bit rate is to provide support for each logical channel, including low priority non-GBR (Guaranteed Bit Rate) bearers, a minimum bit rate in order to avoid a potential starvation. TABLE 1 provides an exemplary configuration for MAC scheduling and priority handling:

TABLE 1

| | Logical Channel | | Prioritized | Bucket Size |
|---|---|---|---|---|
| RB | Identity | Priority | Bit Rate | Duration |
| SRB1 | 1 | 1 | Infinity | 50 ms |
| SRB2 | 2 | 2 | Infinity | 50 ms |
| SRB4 | 4 | 5 | Infinity | 50 ms |
| DRB1 | 5 | 3 | 8 kBps | 100 ms |
| DRB2 | 6 | 4 | 256 kBps | 100 ms |

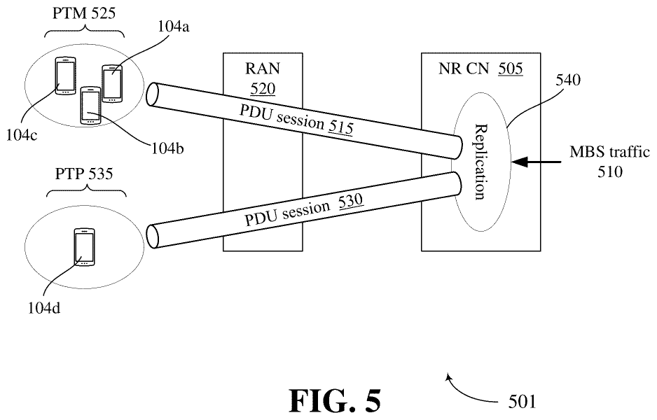

In another aspect of the present disclosure, FIG. 5 is a diagram of communication environment 501 of multicast/broadcast services in NR. NR CN 505 receives MBS traffic 510. NR CN 505 establishes PDU session 515 for MBS traffic 510 via RAN 520 with UEs 104a, 104b, and 104c in point-to-multipoint (PTM) 525. NR CN 505 establishes PDU session 530 for MBS traffic 510 via RAN 520 with UE 104d in point-to-point (PTP) 535. NR CN 505 performs replication process 540 with MBS traffic 510 to support PDU sessions 515 and 530.

MBS has been specified for NR RAT to allow the resource-efficient and reliable transmission of MBS traffic data to multiple UEs in a specific service area at the same time in RAN. For broadcast services, the same content of traffic data will be transmitted to all UEs, whereas in case of multicast services, the same content of traffic data will be transmitted to a group of UEs located in a specific service area. The targeted applications/services for MBS include: (i) Internet protocol television (IPTV); (ii) linear television; (iii) radio; (iv) voice, data, and video group communication; (v) Internet of things (IoT) applications; (vi) V2X application; and (vii) software delivery.

MBS multicast services are supported in RRC_CONNECTED state only, whereas MBS broadcast services are supported in all RRC states, i.e., RRC_IDLE, RRC_INACTIVE and RRC_CONNECTED. An MBS service area consists of one or multiple cells and MBS traffic data can be delivered in each of those cells either per PTM (Point-To-Multipoint) or PTP (Point-To-Point) to the UEs (see example for multicast services in FIG. 5). In the PTM case, the 5G CN receives a single copy of MBS data packets and delivers the single copy of those MBS packets to RAN, which then delivers the packets to multiple UEs. In the PTP case, the 5G CN receives a single copy of MBS data packets and delivers separate copies of those MBS packets to RAN, which then delivers the packets to the UE individually. In general, the use of the MBS delivery methods is dependent on e.g., type of service (broadcast or multicast), the number of MBS-capable UEs located in a service area cell, cell load situation and QoS requirements. For instance, in case of a multicast service when the cell load is high and there are many MBS-capable UEs located in the cell which are receiving or interested in receiving the concerned multicast service, the gNB may decide to deliver traffic data of the multicast service per PTM to the UEs. Otherwise, the gNB may decide to deliver traffic data of the multicast service individually per PTP to the UEs.

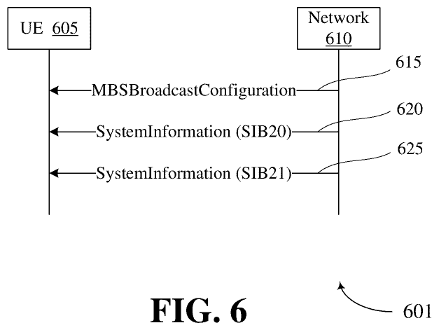

FIG. 6 is a signaling diagram of communication environment 601 between UE 605 and network 610 for reception of MBS broadcast services. With regards to the provisioning of MBS broadcast services in a cell of the MBS service area, network 610 broadcasts the following specified information as specified: (i) The MBSBroadcastConfiguration message 615 contains information about the broadcast services which are transmitted in the current cell and neighboring cells; (ii) SIB20 in SystemInformation message 620 contains information about the AS layer configuration for receiving MBS broadcast services; and (iii) SIB21 in SystemInformation message 625 contains information about the mapping between frequency and MBS broadcast services. With the above broadcast information, an MBS-capable UE in RRC_IDLE and RRC_INACTIVE that is receiving or interested to receive MBS broadcast services may perform cell re-reselection to the cells which provide these MBS broadcast services.

With regard to small data transmission (SDT) in RRC_INACTIVE state, current specifications provide that any unicast uplink/downlink (UL/DL) data transmission is supported in RRC_CONNECTED state only. Hence, a UE in RRC_INACTIVE state has to resume the suspended RRC connection with the network in connected state for any unicast mobile terminated (MT) DL and mobile originated (MO) UL data transmission. Having to connect is inefficient for small and infrequent data packets in terms of signaling overhead and UE power consumption. Therefore, the SDT feature in inactive state is specified to support the efficient transmission of small and infrequent data packets for MO data traffic without the transfer to connected state. Examples of small and infrequent data traffic include the following use cases:
(i) Smartphone applications;
   (a) Traffic from Instant Messaging (IM) services (e.g., Whatsapp, QQ, Wechat);
   (b) Heartbeat/keep-alive traffic from IM/email clients and other applications;
   (c) Push notifications from various applications;
(ii) Non-smartphone applications:
   (a) Traffic from wearables (e.g., periodic positioning information);
   (b) Sensors (e.g., Industrial Wireless Sensor Networks transmitting temperature, pressure readings periodically or in an event-triggered manner); and
   (c) Smart meters and smart meter networks sending periodic meter readings.

SDT in inactive state can be performed by the SDT-capable UE when SDT resources (Random Access Channel (RACH) and/or Configured Grant (CG) resources) have been configured by base node (gNB) via broadcast and/or dedicated signaling, and when the amount of UL data across all radio bearers for which SDT has been enabled is lower than a configured data volume threshold (DVT). When the amount of UL data across all radio bearers for which SDT has been enabled is larger than a configured data volume threshold, the UE initiates legacy RRC connection resume procedure to resume the UL data transmission in connected state.

The UL data transmissions in inactive state can be initiated by UE using contention-based 2-step or 4-step RACH resources (referred to as random access-small data transmission (RA-SDT) resources) or type 1 configured grant-small data transmission (CG-SDT) resources, i.e., pre-configured Physical Uplink Shared Channel (PUSCH) resources, when the UE has a valid uplink Timing Alignment (TA). The RA-SDT resources are configured by the gNB that supports SDT via system information (SIB1), whereas the CG-SDT resources are configured by gNB via dedicated signaling in the RRCRelease message. Furthermore, the UL data transmissions can be performed by UE on either the normal uplink (NUL) carrier or supplemental uplink (SUL) carrier if both UE and network support SUL. That means, the RA-SDT and CG-SDT resources may be configured on both UL carriers, and the configured resources on the UL carriers for RA-SDT and CG-SDT can be the same or different.

After the initial PUSCH transmission during the SDT procedure (either by contention-based RACH or CG), subsequent UL transmissions are handled differently depending on the type of resource used to initiate the SDT procedure:
(i) When using CG resources, the gNB can schedule subsequent UL transmissions using dynamic grants or the transmissions can take place on the following CG resource occasions. The DL transmissions are scheduled using dynamic assignments. The UE can initiate subsequent UL transmission only after reception of confirmation for the initial PUSCH transmission from the gNB.
(ii) When using RACH resources, the gNB can schedule subsequent UL and DL transmissions using dynamic UL grants and DL assignments, respectively, after the completion of the RA procedure.

SDT is enabled by gNB on a radio bearer basis: (i) SRB1 for carrying RRC messages is enabled per default; (ii) SRB2 for carrying NAS messages is enabled by explicit configuration using the RRCRelease message; and (iii) One or multiple DRBs for carrying user data are enabled by explicit configuration using the RRCRelease message.

In order for the UE to determine whether SDT can be performed or not, the gNB configures the parameter sdt-DataVolumeThreshold as part of the common SDT configuration in SIB1. The data volume threshold can be set in the value range {32, 100, 200, 400, 600, 800, 1000, 2000, 4000, 8000, 9000, 10000, 12000, 24000, 48000, 96000} in bytes. If the total amount of UL data across all radio bearers for which SDT has been enabled is lower than the configured data volume threshold, then the UE initiates SDT. The UE MAC entity performs the data volume calculation considering all data packets of the SDT radio bearers that are buffered in the transmission buffers of the PDCP and RLC entities at the time of data volume calculation.

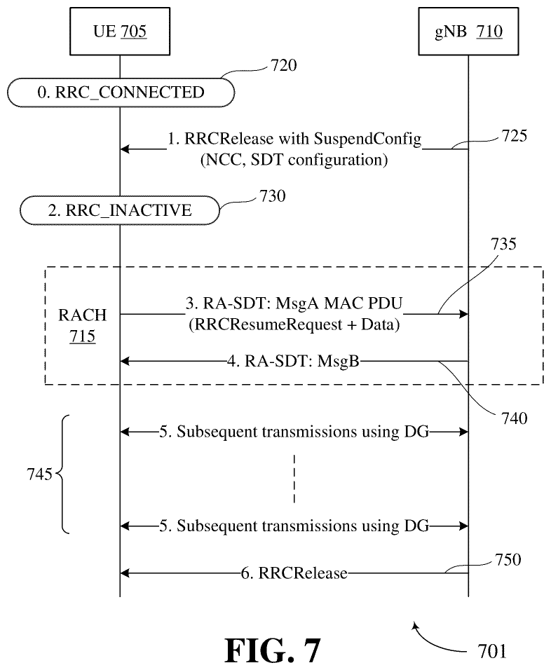

FIG. 7 is an exemplary message flow diagram of a communication environment 701 between UE 705 and base node (gNB) 710 performing RA-based SDT using the contention-based 2-step RACH procedure 715 with subsequent data transmissions. At 720, Step 0: The SDT-capable UE 705 is in connected state.

At 725, Step 1: Due to low UE activity in connected state, the gNB 710 sends the RRCRelease message to transfer the UE 705 to inactive state. The RRCRelease message includes the suspend configuration that includes the NCC value (for generating the security keys to be used for SDT) and the SDT configuration. The SDT configuration includes the radio bearers (SRBs/DRBs) enabled for SDT, the CG-SDT resources and corresponding TA timer configuration for CG-based SDT.

At 730, Step 2: The UE 705 is in inactive state. At 735, Step 3: MO data occurs in the UE 705 and the size of the MO data is below the configured data volume threshold. Sine the UE 705 has no valid TA, UE 705 initiates RA-SDT by using the configured 2-step RACH resources for SDT in SIB1 (i.e., preambles and RACH occasions). The MsgA MAC PDU contains the RRCResumeRequest message and the UL data from the DRB(s) which were configured for SDT.

At 740, Step 4: Upon successful reception of the MsgA MAC PDU, the gNB sends the MsgB to the UE to indicate the successful contention resolution. At 745, Step 5: After the initial UL transmission in step 3, subsequent UL/DL transmissions are performed using dynamic grants (DG).

At 750, Step 6: The gNB 710 sends to the UE 705 the RRCRelease message to reconfigure the NCC value and SDT configuration. Alternatively, the gNB 710 can send to the UE 705 the RRCRelease message to terminate the SDT procedure and to transfer the UE 705 to idle state.

As currently specified, the NR QoE measurement procedure requires that a UE capable of application layer measurement reporting in RRC_CONNECTED may initiate the procedure when configured with application layer measurement, i.e., when appLayerMeasConfig and SRB4 have been configured by the network. Upon initiating the procedure, the UE shall:

| 1> | for each measConfigAppLayerId: | |
|---|---|---|
| | 2> | if the UE AS has received application layer measurement report from upper layers |
| | | which has not been transmitted; and |
| | 2> | if the application layer measurement reporting has not been suspended for the |

```
  measConfigAppLayerId associated with the application layer measurement report
  according to clause 5.3.5.13d:
```

| | |
|---|---|
| 3> | set the measReportAppLayerContainer in the MeasurementReportAppLayer |

message to the received value in the application layer measurement report;

| 2> | set the measConfigAppLayerId in the MeasurementReportAppLayer message to |
|---|---|
| | the value of the measConfigAppLayerId received together with application layer |
| | measurement report information; |
| 2> | if session start or stop information has been received from upper layers for the |

measConfigAppLayerId:

| | |
|---|---|
| 3> | set the appLayerSessionStatus to the received value of the application layer |

measurement information;

| | |
|---|---|
| 2> | if RAN visible application layer measurement report has been received from |

upper layers:

| | |
|---|---|
| 3> | for each appLayerBufferLevel value in the received RAN visible application |

layer measurement report:

| | |
|---|---|
| 4> | set the appLayerBufferLevel values in the appLayerBufferLevelList to the |

buffer level values received from the upper layer in the order with the first
appLayerBufferLevel value set to the newest received buffer level value,
the second appLayerBufferLevel value set to the second newest received
buffer level value, and so on until all the buffer level values received from
the upper layer have been assigned or the maximum number of values
have been set according to appLayerBufferLevel, if configured;

| 3> | set the playoutDelayForMediaStartup to the received value in the RAN visible |
|---|---|
| | application layer measurement report, if any; |
| 3> | for each PDU session ID value indicated in the received RAN visible |

| application layer measurement report, if any: | |
|---|---|
| 4> | set the PDU-SessionID field in the pdu-SessionIdList to the indicated |

PDU session ID value;

| | |
|---|---|
| 2> | if the encoded RRC message is larger than the maximum supported size of one |

PDCP SDU specified in TS 38.323 [5]:

| | |
|---|---|
| 3> | if the RRC message segmentation is enabled based on the field rrc- |

SegAllowed received in appLayerMeasConfig:

| | |
|---|---|
| 4> | initiate the UL message segment transfer procedure as specified in clause |

5.7.7;

| | |
|---|---|
| 3> | else: |

| | |
|---|---|
| 4> | discard the RRC message; |

| | |
|---|---|
| 2> | else: |

| | |
|---|---|
| 3> | submit the MeasurementReportAppLayer message to lower layers for |

transmission upon which the procedure ends.

The present disclosure modifies NR QoE application layer measurement reporting procedure to operate while the UE 705 is in inactive state.

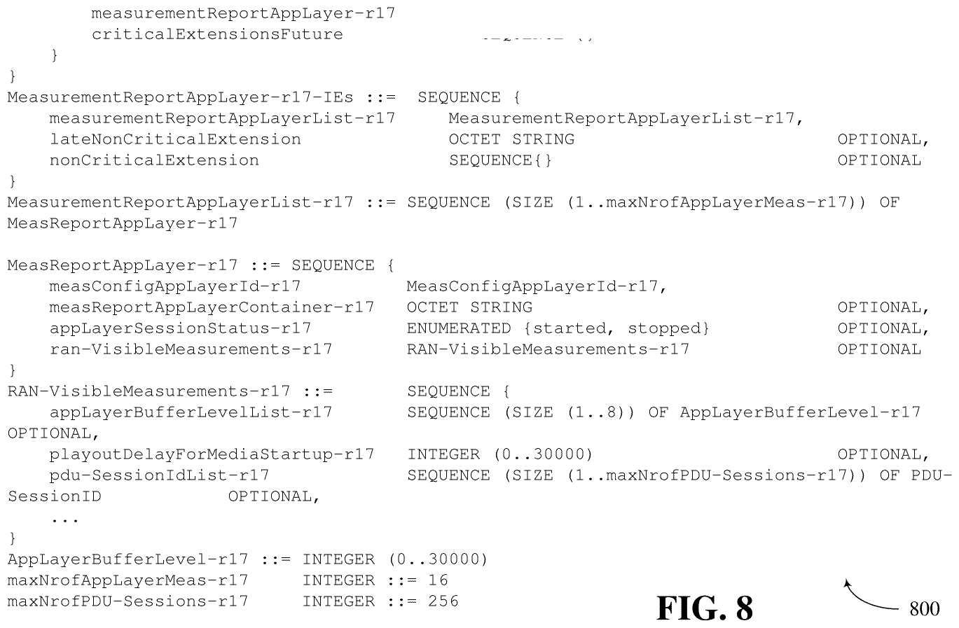

FIG. 8 is an ASN.1 structure 800 of the MeasurementReportAppLayer message according to the specified procedure. The UE AS layer initiates the reporting procedure when there are QoE reports (e.g., regular QoE measurement reports, QoE measurement session status indications, and RVQoE measurement reports) available in RRC sublayer for transmission. The UE AS layer then creates and submits the MeasurementReportAppLayer message to lower layers as follows:
(i) For each QoE measurement configuration identity (measConfigAppLayerId in ASN.1), the UE AS layer creates the IE MeasReportAppLayer and includes the available QoE reports corresponding to this QoE measurement configuration identity into that IE.
(ii) Each created IE MeasReportAppLayer is then concatenated into the MeasurementReportAppLayerList and the UE AS layer determines the resulting size of the MeasurementReportAppLayer message.
(iii) If the size of the RRC message is larger than the maximum size of an RRC message of 9000 bytes and UL RRC segmentation is enabled by network, then the UE AS layer performs segmentation of the message. The UE AS layer ensures that the size of each segment is less than or equal to the RRC message size limit. Each segment is then included in the ULDedicatedMessageSegment message and submitted to lower layers.
(iv) If the size of the RRC message is larger than the maximum size of an RRC message of 9000 bytes and UL RRC segmentation is not enabled by network, then the UE AS layer discards the RRC message.
(v) If the size of the RRC message is smaller than the maximum size of an RRC message of 9000 bytes, then the UE AS layer submits the RRC message to lower layers.

Aspects of the present disclosure modify the ASN.1 structure for operation while the UE 705 (FIG. 7) is in inactive state.

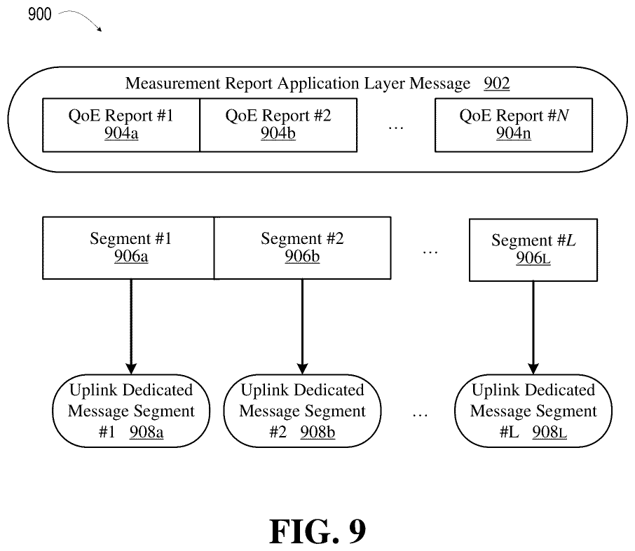

FIG. 9 is a diagram 900 of a measurement report application layer (“MeasurementReportAppLayer”) message 902 whose content is segmented for uplink transmission. FIG. 9 shows an example for creating and transmitting multiple QoE reports in the MeasurementReportAppLayer message if the size of the RRC message exceeds the 9000 bytes size limit and UL segmentation is enabled by the network. In the example, it is assumed that the MeasurementReportAppLayer message carries N QoE reports (QoE report #1 to #N). The RRC message is segmented into L segments and each segment is included in the ULDedicatedMessageSegment message and submitted to lower layers. The ULDedicatedMessageSegment message supports the transmission of up to L=64 segments, which corresponds to a maximum size of the MeasurementReportAppLayer message of 144 kBytes.

Referring to the figure, with segmentation enabled, the user device is able to create and transmit multiple QoE reports that may exceed the 9 kBytes (9000 bytes) size limit for an RRC message. In the example, the measurement report application layer message 902 carries N QoE reports (QoE reports #1, #2, to #N) 904a, 904b, . . . 904n. The RRC message is segmented into L segments (UL dedicated message segments (#1, #2, . . . #L 906a, 906b, . . . 906L) and each segment is included in the UL dedicated message segment (“ULDedicatedMessageSegment”) messages 908a, 908b, . . . 908L, respectively, and submitted to lower layers. QoE reports (#1, #2, to #N) 904a, 904b, . . . 904n that exceed the maximum message size are not discarded prior to segmentation. According to aspects of the present disclosure, discarding of QoE reports is reduced or avoided when segmentation is not enabled, as described below.

Aspects of the present disclosure efficiently support the reporting of collected QoE measurements for MBS in inactive state during the SDT procedure. As part of the dedicated SDT configuration, the gNB indicates in the RRCRelease message whether SRB4 and UL RRC segmentation is enabled for the UE. The parameter “sdt-SRB4-Indication-r18” indicates that SRB4 is enabled for SDT in inactive state. The parameter “sdt-rrc-SegAllowed-r18” indicates that UL RRC segmentation for QoE measurement reporting is enabled for SDT in inactive state.

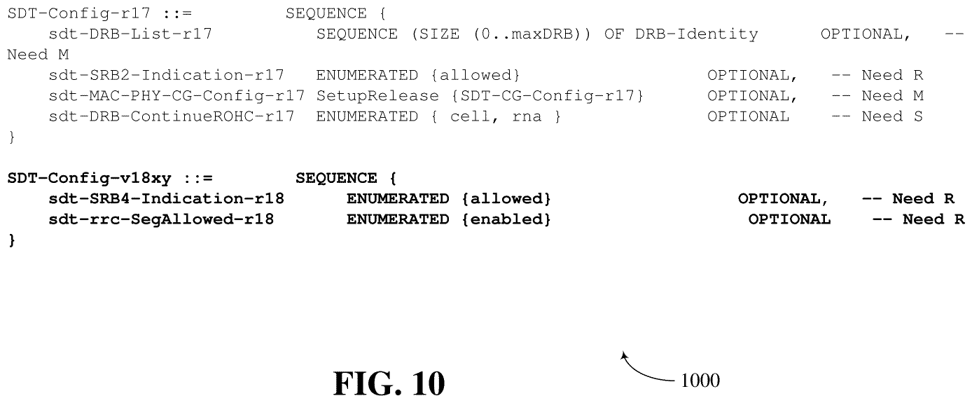

FIG. 10 is an ASN.1 signaling structure 1000 for configuring QoE measurement reporting in SDT. The new parameters are annotated in bold text. The QoE reports that are generated in inactive state are buffered in RRC layer. Furthermore, the RRC buffer is not considered in the calculation of the data volume. Instead, the UE controls the reporting of buffered QoE reports in inactive state according to the actual data volume of the buffers in the PDCP and RLC entities.

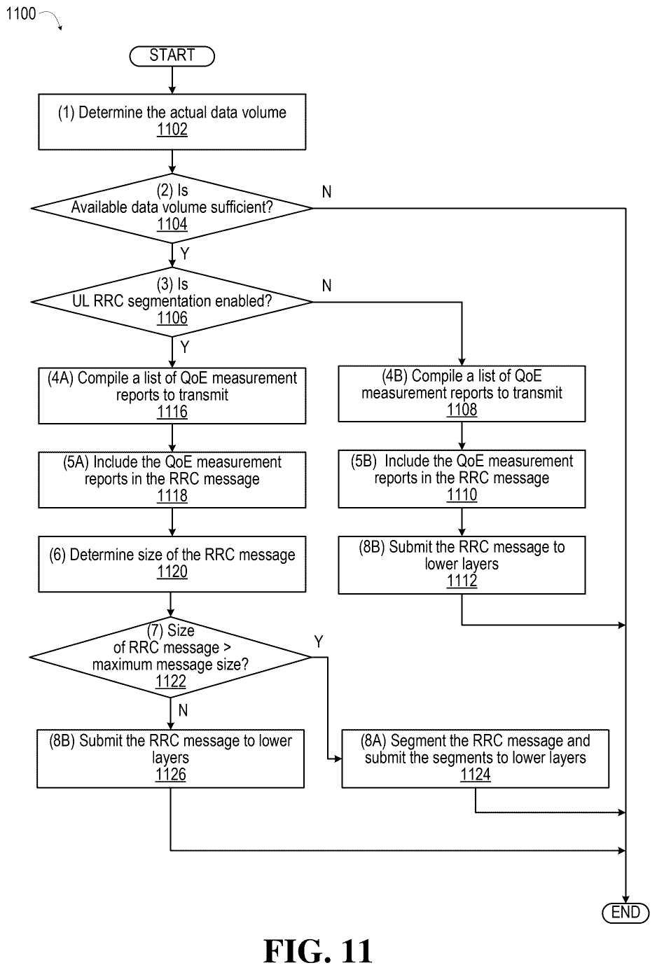

FIG. 11 is a flow diagram that presents a method 1100 for QoE measurement reporting in inactive state. In the flowchart, the term “RRC message” refers to the MeasurementReportAppLayer message and the term “lower layers” refers to the Packet Data Convergence Protocol (PDCP), Radio Link Control (RLC), Medium Access Control (MAC) and Physical (PHY) sublayers. The UE RRC initiates the reporting procedure when there are QoE reports available in the RRC buffer and when the available data volume is sufficient to transmit at least one QoE report to the gNB. The phrase “available data volume” means the remaining data volume of the configured threshold after consideration of the data being available for transmission in PDCP and RLC. The UE RRC creates and submits the MeasurementReportAppLayer message to lower layers as follows:

At 1102, Step 1: The UE RRC determines the actual data volume of the buffers in the PDCP and RLC entities for the RBs which have been configured for SDT. The UE RRC may trigger the MAC entity to provide this information.

At 1104, Step 2: The UE RRC determines the available data volume based on the actual data volume and the configured data volume threshold (given by gNB via SIB1). If the available data volume is insufficient to transmit one or multiple of the buffered QoE reports, then the reporting procedure is stopped. If the available data volume is sufficient, then method 1100 proceeds with the enhanced QoE measurement reporting procedure by the UE RRC for SDT in step 3.

At 1106, Step 3: the UE RRC checks whether UL RRC segmentation has been enabled by the gNB. At 1108, Step 4B: If UL RRC segmentation has not been enabled by the gNB, the UE RRC compiles a list of QoE measurement reports to transmit, considering the available data volume and the maximum RRC PDU size of 9 kBytes. At 1110, Step 5B: The UE RRC includes the QoE reports from the compiled list in the RRC message. At 1112, Step 8B: If the size of the RRC message is smaller than 9000 bytes, then the UE RRC directly submits the RRC message to lower layers. If after Step 8B there are still buffered QoE reports in RRC, the UE RRC initiates a new reporting procedure to transmit the remaining reports to the network (not depicted). If after Step 8B there are no buffered QoE reports in RRC, method 1100 ends.

At 1116, Step 4A: If UL RRC segmentation has been enabled by the gNB at Step 3, the UE RRC compiles a list of QoE reports to transmit, considering the available data volume. At 1118, Step 5A: The UE RRC includes the QoE reports from the compiled list in the RRC message. At 1120, Step 6: The UE RRC determines the size of the RRC message. At 1122, Step 7: The UE RRC checks if the size of the RRC message is larger than 9000 bytes. At 1124, Step 8A: If the size of the RRC message is larger than 9000 bytes, then the UE RRC segments the RRC message and submits the message segments to lower layers. At 1126, Step 8B: If the size of the RRC message is smaller than 9000 bytes, then the UE RRC directly submits the RRC message to lower layers. After 1124 or 1126, if there are still buffered QoE reports in RRC, the UE RRC initiates a new reporting procedure to transmit them to the network (not depicted).

As an alternative solution, the UE only considers the data buffered in PDCP/RLC entities for initiating SDT procedure and then the buffered QoE reports are treated as subsequent UL SDT data. As a consequence, UL RRC segmentation (if enabled) may be performed irrespective of the (remaining) data volume/threshold. This is a solution where the implementation determines when to move the QoE reports to the PDCP layer (after SDT has been initiated).

The proposed solutions have the following advantages: (i) The UE can control the reporting of buffered QoE reports in inactive state during the SDT procedure so that the total data volume does not exceed the configured data volume threshold; and (ii) The UE can transmit buffered QoE reports during the SDT procedure and does not need to initiate legacy RRC connection resume procedure to resume the QoE measurement reporting in connected state.

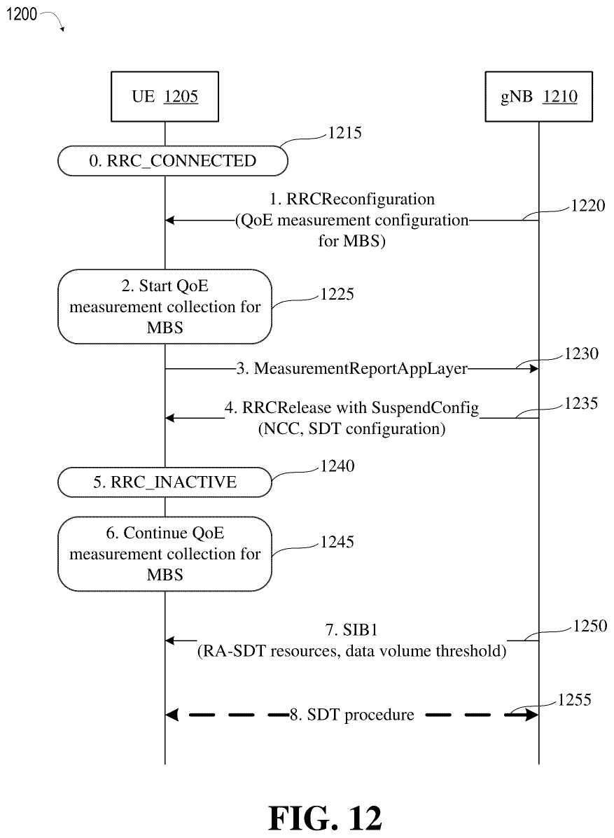

FIG. 12 is a message flow diagram of a communication network 1200 of UE 1205 and gNB 1210 performing one embodiment of the proposed solutions, based on the following assumptions:
(i) Both the gNB and UE support QMC for MBS and SDT.
(ii) OAM is interested in receiving QoE measurements for an MBS multicast service and an MBS broadcast service from UEs which are being served in the Public Land Mobile Network (PLMN), and OAM sends to CN a “Configure QoE measurement” message including the QoE measurement configurations for the concerned MBS services.
(iii) In accordance with the received QoE measurement configurations from OAM, the CN sends to gNB an “Activate QoE measurement” message including the QoE measurement configurations for the concerned MBS services.

At 1215, Step 0: The UE is in a connected state and is receiving unicast services and MBS multicast and broadcast services as well. At 1220, Step 1: The gNB determines that the UE is qualified for QoE measurement collection for the concerned MBS services and sends the RRCReconfiguration message containing the respective QoE measurement configurations (i.e., QoE configuration identity #1 for the MBS multicast service and QoE configuration identity #2 for the MBS broadcast service).

At 1225, Step 2: The UE AS layer sends the received QoE measurement configurations to its AL, and the AL starts QoE measurement collection in accordance with the received QoE measurement configurations and received MBS services.

At 1230, Step 3: According to the configured reporting interval in the QoE measurement configurations, the UE AL sends first collected measurement results to the UE AS layer in a QoE measurement report. The UE AS layer sends the QoE measurement report via the MeasurementReportAppLayer message to the gNB, and the gNB forwards the received QoE measurement report to Measurement Collection Entity (MCE) (not shown in FIG. 12).

At 1235, Step 4: Due to low UE activity in transmitting/receiving unicast data in connected state, the gNB sends the RRCRelease message including suspend configuration to transfer the UE to inactive state. The suspend configuration includes the NextHop Chaining Counter (NCC) value (for generating the security keys to be used for SDT) and the SDT configuration. The SDT configuration includes the signaling radio bearers (SRBs) and data radio bearers (DRBs) enabled for SDT, the CG-SDT resources, and corresponding TA timer configuration for CG-based SDT. In the example, both SRB4 and UL RRC segmentation have been enabled in the SDT configuration. As result, the UE AS layer applies the UL AS protocol layer configuration as shown in FIG. 4.

At 1240, Step 5: The UE is in inactive state. At 1245, Step 6: The UE continues with reception of the MBS services and with the QoE measurement collection. The QoE measurement configurations for MBS have not been released by the gNB in the RRCRelease message. The QoE reports that are generated in inactive state are buffered in RRC layer. The size of the RRC buffer is 64 kBytes.

At 1250, Step 7: The UE receives SIB1 including the configuration of RA-SDT resources and data volume threshold set to 96 kBytes. At 1255, Step 8: UL data appear in the layer 2 buffers of the RBs that have been enabled for SDT. Therefore, the UE MAC initiates SDT, and UL/DL data transmissions are performed between the UE and gNB in inactive state. For reporting of the buffered QoE reports, the UE initiates the enhanced QoE measurement reporting procedure for SDT, as shown in FIG. 11.

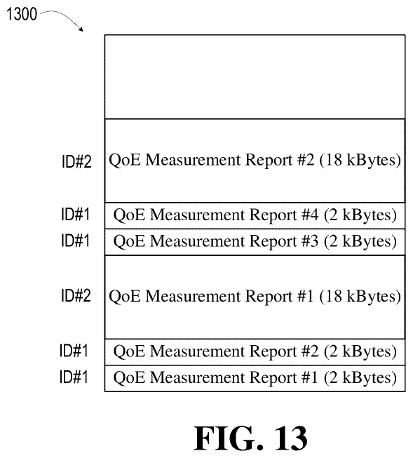

FIG. 13 is a diagram of the RRC buffer status 1300. Overall, six (6) QoE reports of total 44 kBytes are buffered for transmission (i.e., four (4) QoE reports for QoE configuration identity #1 and two (2) QoE reports for QoE configuration identity #2). The actual data volume of the buffers in the PDCP and RLC entities is 32 kBytes (i.e., data available for transmission in PDCP/RLC). The available/remaining data volume is 64 kBytes, which is sufficient to transmit all buffered QoE reports per segmented RRC messages to lower layers and the gNB. As a result, the UE RRC performs steps 1, 2, 3, 4A, 5A, 6, 7 and 8A according to FIG. 11.

In a second embodiment, with reference to FIG. 11, the assumptions and the message flow are mostly the same as for the above-described first embodiment, except for the following: At 1116, Step 4: In the SDT configuration, the UL RRC segmentation has not been enabled by the gNB. At 1122, Step 7: In SIB1, the data volume threshold has been set to 48 kBytes. Otherwise, the assumptions are the same as for the first described embodiment. In the present embodiment, the actual data volume of the buffers in the PDCP and RLC entities is 32 kBytes (i.e., data available for transmission in PDCP/RLC). That means that the available/remaining data volume is 16 kBytes, which is not sufficient to transmit all buffered QoE reports to the gNB. As a result, the UE RRC performs steps 1, 2, 3, 4B, 5B and 8B according to FIG. 11 to transmit the four (4) QoE reports for QoE configuration identity #1 via a single MeasurementReportAppLayer message to lower layers and the gNB. That means the UE creates one RRC message of size 8 kBytes and sends the RRC message to lower layers, so that the total data volume is not greater than 48 kBytes and SDT can be initiated by the UE MAC. The remaining buffered QoE reports are sent by the UE RRC in a subsequent QoE measurement reporting procedure.

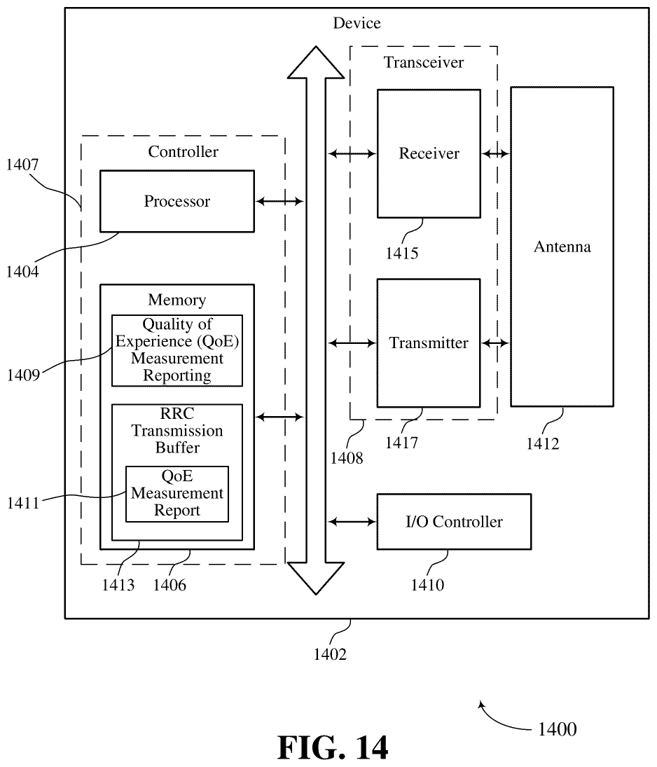

FIG. 14 illustrates an example of a block diagram 1400 of a device 1402 that supports wireless communication with enhanced QoE measurement reporting, in accordance with aspects of the present disclosure. The device 1402 may be an example of a network entity or network device 102 or a UE 104 (FIG. 1), as described herein. The device 1402 may support wireless communication with one or more network entities or network devices 102, UEs 104, or any combination thereof. The device 1402 may include components for bi-directional communications including components for transmitting and receiving communications, such as a processor 1404, a memory 1406, a transceiver 1408, and an I/O controller 1410. These components may be in electronic communication or otherwise coupled (e.g., operatively, communicatively, functionally, electronically, electrically) via one or more interfaces (e.g., buses).

The processor 1404, the memory 1406, the transceiver 1408, or various combinations thereof or various components thereof may be examples of means for performing various aspects of the present disclosure as described herein. For example, the processor 1404, the memory 1406, the transceiver 1408, or various combinations or components thereof may support a method for performing one or more of the operations described herein.

In some implementations, the processor 1404, the memory 1406, the transceiver 1408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. A controller 1407 includes the processor 1404 and configures the device 1402 to perform the functionality of the present disclosure. The controller 1407 is communicatively coupled to the memory 1406 to execute program code. Controller 1407 may include dedicated memory solely accessible by the processor 1404 that is a portion of memory 1406. In some implementations, the processor 1404 and the memory 1406 coupled with the processor 1404 may be configured to perform one or more of the functions as a controller 1407 described herein (e.g., executing, by the processor 1404, instructions stored in the memory 1406).

The processor 1404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1404 may be configured to operate a memory array using a memory controller. In some other implementations, a memory controller may be integrated into the processor 1404. The processor 1404 may be configured to execute computer-readable instructions stored in a memory (e.g., the memory 1406) to cause the device 1402 to perform various functions of the present disclosure.

The memory 1406 may include random access memory (RAM) and read-only memory (ROM). The memory 1406 may store computer-readable, computer-executable code including instructions that, when executed by the processor 1404 cause the device 1402 to perform various functions described herein. The code may be stored in a non-transitory computer-readable medium such as system memory or another type of memory. In some implementations, the code may not be directly executable by the processor 1404 but may cause a computer (e.g., when compiled and executed) to perform functions described herein. In some implementations, the memory 1406 may include, among other things, a basic I/O system (BIOS) which may control basic hardware or software operation such as the interaction with peripheral components or devices.

In an example, the controller 1407 may support wireless communication at the device 1402 in accordance with examples as disclosed herein. In one or more embodiments, the memory 1406 stores a QoE measurement reporting application 1409 that, when executed by the processor 1404, configures the device 1402 to process and transmit QoE measurement reports 1411 in an RRC transmission buffer 1413 in the memory 1406. The RRC transmission buffer 1413 is associated with a signaling radio bearer for transmitting an RRC message carrying QoE measurement reports.

The I/O controller 1410 may manage input and output signals for the device 1402. The I/O controller 1410 may also manage peripherals not integrated into the device 1402. In some implementations, the I/O controller 1410 may represent a physical connection or port to an external peripheral. In some implementations, the I/O controller 1410 may utilize an operating system such as iOS®, ANDROID®, MS-DOS®, MS-WINDOWS®, OS/2®, UNIX®, LINUX®, or another known operating system. In some implementations, the I/O controller 1410 may be implemented as part of a processor, such as the processor 1404. In some implementations, a user may interact with the device 1402 via the I/O controller 1410 or via hardware components controlled by the I/O controller 1410.

In some implementations, the device 1402 may include a single antenna 1412. However, in some other implementations, the device 1402 may have more than one antenna 1412 (i.e., multiple antennas), including multiple antenna panels or antenna arrays, which may be capable of concurrently transmitting or receiving multiple wireless transmissions. The transceiver 1408 may communicate bi-directionally using one or more receivers 1415 and one or more transmitters 1417, via the one or more antennas 1412, wired, or wireless links as described herein. For example, the transceiver 1408 may represent a wireless transceiver and may communicate bi-directionally with another wireless transceiver. The transceiver 1408 may also include a modem to modulate the packets, to provide the modulated packets to one or more antennas 1412 for transmission, and to demodulate packets received from the one or more antennas 1412.

According to one or more aspects of the present disclosure, the device 1402 may be used as a user device such as UE 104 (FIG. 1). The device 1402 includes a transceiver 1408 including at least one receiver 1415 and at least one transmitter 1417 that enable the device 1402 to communicate with a network device 102 (FIG. 1). The device 1402 includes a memory 1406 having a buffer 1413. A controller 1407 of the device 1402 is communicatively coupled to the memory 1406 and the transceiver 1408. The controller 1407 receives, via the transceiver 1408 from the network device 102 (FIG. 1), one or more control messages. The controller 1407 determines that the one or more control messages enable small data transmission using a first allocation of uplink resources while at least the transceiver 1408 of the device 1402 is in an inactive state and enables generation and transmission of quality of experience (QoE) measurement reports. In response, the controller 1407 measures QoE at the device 1402 and stores one or more QoE measurement reports 1411 in the buffer. The controller 1407 reports, using small data transmission (SDT) in at least one first uplink message while at least the transceiver 1408 of the device 1402 is in an inactive state, a first list of a portion of the one or more QoE measurement reports 1411 limited to the first allocation of uplink resources for SDT. The buffer may then contain an unreported portion of the one or more QoE measurement reports 1411. The device 1402 may subsequently receive a second allocation of uplink resources for SDT. Alternatively, the device 1402 may designate an unused portion of the first allocation as a second allocation of uplink resources for SDT. While remaining in the inactive state, the device 1402 reports, using SDT, a second portion of the one or more QoE measurement reports 1411 in a second list.

In one or more embodiments, the one or more control messages include an SDT configuration of the first allocation and second allocation of uplink resources for SDT that include random access (RA) SDT resources and configured grant (CG) SDT resources. In one or more embodiments, the controller 1407 executes a Radio Resource Control (RRC) and a Medium Access Control (MAC) of the device 1402. The first allocation and the second allocation are portions of a data volume that the RRC receives from the MAC of the device 1402 that are used to determine, respectively, the first and the second lists of the one or more QoE measurement reports 1411.

In one or more embodiment, the controller 1407 segments any of the one or more uplink messages that has the identified message size that exceeds a maximum message size limit in response to determining that the one or more control messages further enable segmentation of uplink messages. In one or more embodiments, the QoE measurement reports are based on multicast and broadcast service (MBS) transmitted by the network device 102 (FIG. 1).

In one or more embodiments, in response to determining that the one or more control messages does not enable segmentation of uplink messages for carrying the one or more QoE measurement reports 1411, the controller 1407 identifies a message size for each of the one or more QoE measurement reports 1411 in the buffer 1413. The controller 1407 removes from the buffer 1413 any of the one or more QoE measurement reports 1411 that has an identified message size that exceeds a maximum message size limit. The controller 1407 assigns the one or more QoE measurement reports 1411 that remain within the buffer 1413 to one or more uplink messages that individually do not exceed the maximum message size limit. The controller 1407 transmits, via the transceiver 1408, the one or more uplink messages to the network device 102 (FIG. 1).

In one or more embodiments, the buffer 1413 is a radio resource control (RRC) transmission buffer that is associated with a signaling radio bearer for transmitting an RRC message carrying QoE measurement reports 1411. In one or more embodiments, the controller 1407 discards from the buffer 1413 each of the QoE measurement reports that is transmitted in one or more uplink messages. In one or more embodiments, the controller 1407 receives multicast and broadcast service (MBS) from the network device 102 (FIG. 1) and generates the QoE measurement reports 1411 based on the MBS.

According to one or more aspects of the present disclosure, the device 1402 is a network device for wireless communication with at least one user device (e.g., UE 104 (FIG. 1)). In one or more embodiments, the device 1402 includes a transceiver 1408 including at least one receiver 1415 and at least one transmitter 1417 that enable the device 1402 to communicate with a user device. A controller 1407 of the device 1402 is communicatively coupled to the transceiver 1408. The controller 1407 transmits, via the transceiver 1408 to the user device, one or more control messages to enable: (i) small data transmission (SDT) while at least the transceiver of the user device is in an inactive state using a first allocation and subsequent second allocations of uplink resources for SDT; and (ii) generation of quality of experience (QoE) measurement reports, prompting the user device to measure QoE and store one or more QoE measurement reports in a buffer. The controller 1407 receives from the user device in at least one first uplink message while at least the transceiver of the user device is in an inactive state, a first list of a portion of the one or more QoE measurement reports limited to a first allocation of uplink resources for SDT. The controller 1407 receives from the user device in at least one other uplink message while at least the transceiver of the user device is in an inactive state, a second list of a portion of the one or more QoE measurement reports limited to a second allocation of uplink resources for SDT. The controller 1407 communicates the first list and the second list to a Measurement Collection Entity (MCE) 302 (FIG. 3).

In one or more embodiments, the one or more control messages further include an indication that segmentation of uplink messages is enabled, and the transceiver 1408 de-segments any of the one or more uplink messages that has the identified message size that exceeds a maximum message size limit. In one or more embodiments, the controller 1407, via the transceiver 1408, transmits multicast and broadcast service (MBS) to the user device. The QoE measurement reports are based on the MBS.

In one or more embodiments, the first allocation and the second allocation define a signaling radio bearer for transmitting a radio resource control (RRC) message carrying QoE measurement reports. In one or more embodiments, the one or more control messages prompt the user device to transfer to the inactive state.

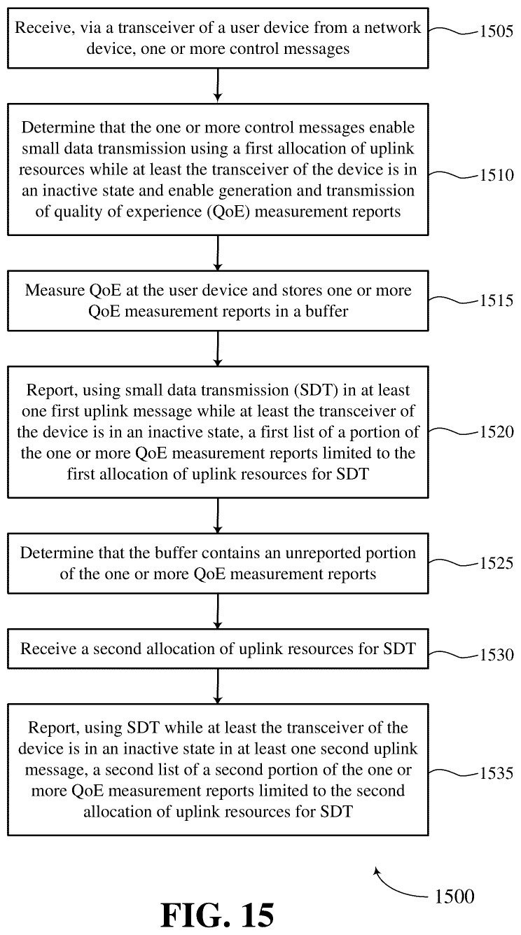

FIG. 15 illustrates a flowchart of a method 1500 that supports wireless communication by a user device with a network device, in particular with enhanced QoE measurement reporting, in accordance with aspects of the present disclosure. The operations of the method 1500 may be implemented by a user device or its components as described herein. For example, the operations of the method 1500 may be performed by a UE 104 or device 1402 as described with reference to FIGS. 1 and 14. In some implementations, the device may execute a set of instructions to control the function elements of the device to perform the described functions. Additionally, or alternatively, the device may perform aspects of the described functions using special-purpose hardware.

At 1505, the method 1500 may include receiving, via a transceiver of a user device from a network device, one or more control messages. The operations of 1505 may be performed in accordance with examples as described herein. In some implementations, aspects of the operations of 1505 may be performed by a device as described with reference to FIG. 1 or 14.

At 1510, the method 1500 may include determining that the one or more control messages enable small data transmission using a first allocation of uplink resources while at least the transceiver of the device is in an inactive state and enable generation and transmission of quality of experience (QoE) measurement reports. The operations of 1510 may be performed in accordance with examples as described herein. In some implementations, aspects of the operations of 1510 may be performed by a device as described with reference to FIG. 1 or 14.

At 1515, the method 1500 may include measuring QoE at the user device and storing one or more QoE measurement reports in a buffer. The operations of 1515 may be performed in accordance with examples as described herein. In some implementations, aspects of the operations of 1515 may be performed by a device as described with reference to FIG. 1 or 14.

At 1520, the method 1500 may include reporting, using small data transmission (SDT) in at least one first uplink message while at least the transceiver of the device is in an inactive state, a first list of a portion of the one or more QoE measurement reports limited to the first allocation of uplink resources for SDT. The operations of 1520 may be performed in accordance with examples as described herein. In some implementations, aspects of the operations of 1520 may be performed by a device as described with reference to FIG. 1 or 14.

At 1525, the method 1500 may include determining that the buffer contains an unreported portion of the one or more QoE measurement reports. The operations of 1525 may be performed in accordance with examples as described herein. In some implementations, aspects of the operations of 1525 may be performed by a device as described with reference to FIG. 1 or 14.

At 1530, the method 1500 may include receiving a second allocation of uplink resources for SDT. The operations of 1530 may be performed in accordance with examples as described herein. In some implementations, aspects of the operations of 1530 may be performed by a device as described with reference to FIG. 1 or 14.

At 1535, the method 1500 may include reporting, using SDT while at least the transceiver of the device is in an inactive state in at least one second uplink message, a second list of a second portion of the one or more QoE measurement reports limited to the second allocation of uplink resources for SDT. The operations of 1535 may be performed in accordance with examples as described herein. In some implementations, aspects of the operations of 1535 may be performed by a device as described with reference to FIG. 1 or 14.

In one or more embodiments, the method 1500 may further include segmenting any of the one or more uplink messages that has an identified message size that exceeds a maximum message size limit in response to determining that the one or more control messages further enable segmentation of uplink messages. In one or more embodiments, the method 1500 may further include receiving multicast and broadcast service (MBS) transmitted by the network device. The method 1500 may further include generating the one or more QoE measurement reports based on the MBS.

In one or more embodiments, the method 1500 may further include determining that the one or more control messages does not enable segmentation of uplink messages for carrying the one or more QoE measurement reports. The method 1500 may further include identifying a message size for each of the one or more QoE measurement reports in the buffer. The method 1500 may further include removing, from the buffer, any of the one or more QoE measurement reports that has an identified message size that exceeds a maximum message size limit. The method 1500 may further include assigning the one or more QoE measurement reports that remain within the buffer to one or more uplink messages that individually do not exceed the maximum message size limit. The method 1500 may further include transmitting, via the transceiver, the one or more uplink messages to the network device.

In one or more embodiments, the method 1500 may further include storing the one or more QoE reports in the buffer comprising a radio resource control (RRC) transmission buffer that is associated with a signaling radio bearer for transmitting an RRC message carrying QoE measurement reports. In one or more embodiments, the method 1500 may further include discarding from the buffer each of the QoE measurement reports that is transmitted in one or more uplink messages. In one or more embodiments, the method 1500 may further include receiving, via the transceiver, multicast and broadcast service (MBS) from the network device; and generating the QoE measurement reports based on the MBS.

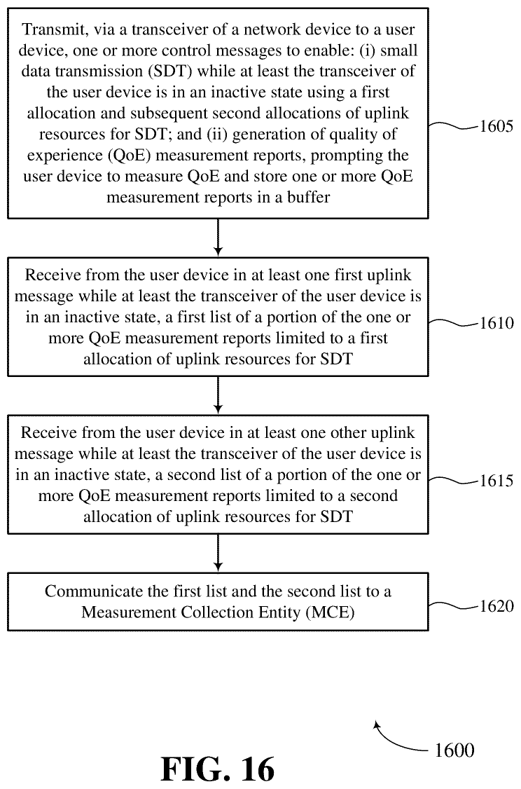

FIG. 16 illustrates a flowchart of a method 1600 that supports wireless communication by a network device with a user device with enhanced QoE measurement reporting, in accordance with aspects of the present disclosure. The operations of the method 1600 may be implemented by a device or its components as described herein. For example, the operations of the method 1600 may be performed by a network device, base node, or network device 102 or device 1402 as described with reference to FIGS. 1 and 14. In some implementations, the network device may execute a set of instructions to control the function elements of the network device to perform the described functions. Additionally, or alternatively, the network device may perform aspects of the described functions using special-purpose hardware.

At 1605, the method may include transmitting, via a transceiver of a network device to a user device, one or more control messages to enable: (i) small data transmission (SDT) while at least the transceiver of the user device is in an inactive state using a first allocation and subsequent second allocations of uplink resources for SDT; and (ii) generation of quality of experience (QoE) measurement reports, prompting the user device to measure QoE and store one or more QoE measurement reports in a buffer. The operations of 1605 may be performed in accordance with examples as described herein. In some implementations, aspects of the operations of 1605 may be performed by a device as described with reference to FIGS. 1 and 14.

At 1610, the method may include receiving from the user device in at least one first uplink message while at least the transceiver of the user device is in an inactive state, a first list of a portion of the one or more QoE measurement reports limited to a first allocation of uplink resources for SDT. The operations of 1610 may be performed in accordance with examples as described herein. In some implementations, aspects of the operations of 1610 may be performed by a device as described with reference to FIGS. 1 and 14.

At 1615, the method may include receiving from the user device in at least one other uplink message while at least the transceiver of the user device is in an inactive state, a second list of a portion of the one or more QoE measurement reports limited to a second allocation of uplink resources for SDT. The operations of 1615 may be performed in accordance with examples as described herein. In some implementations, aspects of the operations of 1615 may be performed by a device as described with reference to FIGS. 1 and 14.

At 1620, the method may include communicating the first list and the second list to a Measurement Collection Entity (MCE). The operations of 1620 may be performed in accordance with examples as described herein. In some implementations, aspects of the operations of 1620 may be performed by a device as described with reference to FIG. 1 or 14.

In one or more embodiments, the method 1600 may include transmitting the one or more control messages that further include an indication that segmentation of uplink messages is enabled; and de-segmenting any of the one or more uplink messages that has an identified message size that exceeds a maximum message size limit.

In one or more embodiments, the method 1600 may further include transmitting multicast and broadcast service (MBS) to the user device, wherein the QoE measurement reports are based on the MBS. In one or more embodiments, the first allocation and the second allocation define a signaling radio bearer for transmitting a radio resource control (RRC) message carrying QoE measurement reports. In one or more embodiments, the one or more control messages prompt the user device to transfer to the inactive state.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, the UE comprising:
at least one memory; and
at least one processor communicatively coupled to the at least one memory and which is configured to cause the UE to:
receives from a base station, one or more control messages; and
in response to determining that the one or more control messages enable small data transmission (SDT) using a first allocation of uplink resources while a transceiver of the UE is in an inactive state and enable generation and transmission of quality of experience (QoE) measurement reports:
measure QoE at the UE and stores one or more QoE measurement reports in a buffer;
report, using SDT in at least one first uplink message while the transceiver is in the inactive state, a first list of a portion of the one or more QoE measurement reports limited to the first allocation of uplink resources for SDT;
in response to determining that the buffer contains an unreported portion of the one or more QoE measurement reports:
receive a second allocation of uplink resources for SDT; and
while the transceiver is in the inactive state, report, using SDT in at least one second uplink message, a second list of a second portion of the one or more QoE measurement reports limited to the second allocation of uplink resources for SDT.

2. The UE of claim 1, wherein the one or more control messages comprise an SDT configuration of the first allocation and second allocation of uplink resources for SDT comprising random access (RA) SDT resources and configured grant (CG) SDT resources.

3. The UE of claim 1, wherein the at least one processor executes a Radio Resource Control (RRC) and a Medium Access Control (MAC) of the UE, and wherein the first allocation and the second allocation are portions of a data volume that the RRC receives from the MAC of the UE and which are used to determine, respectively, the first and the second lists of the one or more QoE measurement reports.

4. The UE of claim 1, wherein the transceiver segments any of the one or more uplink messages that has an identified message size that exceeds a maximum message size limit in response to determining that the one or more control messages further enable segmentation of uplink messages.

5. The UE of claim 1, wherein the controller at least one processor is configured to cause the UE to:
in response to determining that the one or more control messages does not enable segmentation of uplink messages for carrying the one or more QoE measurement reports:
identify a message size for each of the one or more QoE measurement reports in the buffer;
remove, from the buffer, any of the one or more QoE measurement reports that has an identified message size that exceeds a maximum message size limit;
assign the one or more QoE measurement reports that remain within the buffer to one or more uplink messages that individually do not exceed the maximum message size limit; and
transmits the one or more uplink messages to the base station.

6. The UE of claim 1, wherein the buffer comprises a radio resource control (RRC) transmission buffer that is associated with a signaling radio bearer for transmitting an RRC message carrying QoE measurement reports.

7. The UE of claim 1, wherein the at least one processor is configured to cause the UE to discard, from the buffer, each of the QoE measurement reports that is transmitted in one or more uplink messages.

8. The UE of claim 1, wherein the at least one processor is configured to cause the UE to:
receive multicast and broadcast service (MBS) from the base station; and
generate the QoE measurement reports based on the MBS.

9. A controller for wireless communication by a user equipment (UE), the controller comprising:
a memory having (i) program code for enabling quality of experience transmission during an inactive state of a transceiver of the UE and (ii) a radio resource control (RRC) transmission buffer that is associated with a signaling radio bearer for transmitting an RRC message carrying QoE measurement reports; and
a processor communicatively coupled to the memory, and which is configured to cause the controller to:
receive, from a base station, one or more control messages; and
in response to determining that the one or more control messages enable SDT using a first allocation of uplink resources while a transceiver of the UE is in an inactive state and enable generation and transmission of quality of experience (QoE) measurement reports:
measure QoE at the user equipment and store one or more QoE measurement reports in a buffer;
report, using SDT in at least one first uplink message while the transceiver is in an inactive state, a first list of a portion of the one or more QoE measurement reports limited to the first allocation of uplink resources for SDT;
in response to determining that the buffer contains an unreported portion of the one or more QoE measurement reports:
receive a second allocation of uplink resources for SDT; and
while the transceiver is in the inactive state, report, using SDT in at least one second uplink message, a second list of a second portion of the one or more QoE measurement reports limited to the second allocation of uplink resources for SDT.

10. The controller of claim 9, wherein the one or more control messages comprise an SDT configuration of the first allocation and second allocation of uplink resources for SDT comprising random access (RA) SDT resources and configured grant (CG) SDT resources.

11. The controller of claim 9, wherein the processor is configured to cause the controller to execute a Radio Resource Control (RRC) and a Medium Access Control (MAC) of the UE, and wherein the first allocation and the second allocation are portions of a data volume that the RRC receives from the MAC of the UE and which are used to determine, respectively, the first and the second lists of the one or more QoE measurement reports.

12. The controller of claim 9, wherein the processor is configured to cause the controller to:
segment any of the one or more uplink messages that has an identified message size that exceeds a maximum message size limit in response to determining that the one or more control messages further enable segmentation of uplink messages; and
in response to determining that the one or more control messages does not enable segmentation of uplink messages for carrying the one or more QoE measurement reports:
identify a message size for each of the one or more QoE measurement reports in the buffer;
remove, from the buffer, any of the one or more QoE measurement reports that has an identified message size that exceeds a maximum message size limit;
assign the one or more QoE measurement reports that remain within the buffer to one or more uplink messages that individually do not exceed the maximum message size limit; and
transmit, via the transceiver, the one or more uplink messages to the base station.

13. The controller of claim 9, wherein the processor is configured to cause the controller to:
receive multicast and broadcast service (MBS) from the base station; and
generate the QoE measurement reports based on the MBS.

14. A method for wireless communication at a user equipment (UE), the method comprising:
receiving, base station, one or more control messages; and
in response to determining that the one or more control messages enable small data transmission using a first allocation of uplink resources while a transceiver of the UE is in an inactive state and enable generation and transmission of quality of experience (QoE) measurement reports:
measuring QoE at the UE and storing one or more QoE measurement reports in a radio resource control (RRC) transmission buffer that is associated with a signaling radio bearer for transmitting an RRC message carrying QoE measurement reports;
reporting, using small data transmission (SDT) in at least one first uplink message while at least the transceiver of the UE is in an inactive state, a first list of a portion of the one or more QoE measurement reports limited to the first allocation of uplink resources for SDT; and
in response to determining that the buffer contains an unreported portion of the one or more QoE measurement reports:
receiving a second allocation of uplink resources for SDT; and
reporting, using SDT while at least the transceiver of the UE is in an inactive state in at least one second uplink message, a second list of a second portion of the one or more QoE measurement reports limited to the second allocation of uplink resources for SDT;
wherein the one or more control messages comprise an SDT configuration of the first allocation and second allocation of uplink resources for SDT comprising random access (RA) SDT resources and configured grant (CG) SDT resources; and
wherein the one or more control messages configure a Radio Resource Control (RRC) and a Medium Access Control (MAC) of the UE, wherein the first allocation and the second allocation are portions of a data volume that the RRC receives from the MAC of the UE that are used to determine, respectively, the first and the second lists of the one or more QoE measurement reports.

15. The method of claim 14, further comprising:
segmenting any of the one or more uplink messages that has an identified message size that exceeds a maximum message size limit in response to determining that the one or more control messages further enable segmentation of uplink messages; and
in response to determining that the one or more control messages does not enable segmentation of uplink messages for carrying the one or more QoE measurement reports:
identifying a message size for each of the one or more QoE measurement reports in the buffer;
removing, from the buffer, any of the one or more QoE measurement reports that has an identified message size that exceeds a maximum message size limit;
assigning the one or more QoE measurement reports that remain within the buffer to one or more uplink messages that individually do not exceed the maximum message size limit; and
transmitting the one or more uplink messages to the base station.

16. A base station for wireless communication, the base station comprising:
a at least one memory; and
at least one processor communicatively coupled to the at least one memory, and which is configured to cause the base station to:
transmit, to a user equipment (UE), one or more control messages to enable: (i) small data transmission (SDT) while a transceiver of the UE is in an inactive state using a first allocation and subsequent second allocations of uplink resources for SDT; and (ii) generation of quality of experience (QoE) measurement reports, prompting the UE to measure QoE and store one or more QoE measurement reports in a buffer;
receive from the UE in at least one first uplink message while at least the transceiver of the UE is in an inactive state, a first list of a portion of the one or more QoE measurement reports limited to a first allocation of uplink resources for SDT;
receive from the UE in at least one other uplink message while at least the transceiver of the UE is in an inactive state, a second list of a portion of the one or more QoE measurement reports limited to a second allocation of uplink resources for SDT; and
communicate the first list and the second list to a Measurement Collection Entity (MCE).

17. The base station of claim 16, wherein:
the one or more control messages comprise an SDT configuration of the first allocation and second allocation of uplink resources for SDT comprising random access (RA) SDT resources and configured grant (CG) SDT resources; and
the one or more control messages configure a Radio Resource Control (RRC) and a Medium Access Control (MAC) of the UE, wherein the first allocation and the second allocation are portions of a data volume that the RRC receives from the MAC of the UE that are used to determine, respectively, the first and the second lists of the one or more QoE measurement reports.

18. The base station of claim 16, wherein the one or more control messages further include an indication that segmentation of uplink messages is enabled, and the transceiver de-segments any of the one or more uplink messages that has an identified message size that exceeds a maximum message size limit.

19. The base station of claim 16, wherein the processor is configured to cause the base station to transmit multicast and broadcast service (MBS) to the UE, wherein the QoE measurement reports are based on the MBS.

20. The base station of claim 16, wherein the one or more control messages define a signaling radio bearer for transmitting a radio resource control (RRC) message carrying QoE measurement reports and prompt the UE to transfer to the inactive state.
